(19) United States
(12) Patent Application Publication
(10) Pub. No.: US 2026/0048347 A1
(43) Pub. Date: Feb. 19, 2026

(54) FILTER SYSTEM

(71) Applicant: Indufil BV, Duiven (NL)

(72) Inventors: Jasper Oranje, Duiven (NL); Thomas Doerfler, Duiven (NL)

(21) Appl. No.: 19/103,938

(22) PCT Filed: Aug. 29, 2023
(86) PCT No.: PCT/EP2023/073704

§ 371 Date: Feb. 14, 2025

(30) Foreign Application Priority Data
Aug. 31, 2022 (GB) 2212601.5

(51) Int. Cl. B01D 29/90; B01D 29/21

(52) U.S. Cl. CPC B01D 29/902; B01D 29/21; B01D 2201/44

(57) ABSTRACT

Liquid filter systems, flow spreaders and filter elements for improving flow are provided. A liquid filter system can comprise: a chamber having an inlet at its upper end and an outlet at its lower end; a filter element having a hollow interior volume, the filter element arranged in the chamber to filter the liquid flow by passage into the low interior volume to the chamber outlet; and a flow spreader having an inclined surface forming an apex, the flow spreader arranged at the upper end of the filter element to receive a columnar liquid flow from the inlet of the chamber at the apex of the inclined surface and to provide an annular liquid flow past the upper end of the filter element into an annular gap between the filter wall of the filter element and the lateral wall of the chamber.

The present disclosure relates to filter systems. In particular, the present disclosure relates to a liquid filter system for improving the flow of liquids in the filter system. The present disclosure also relates to a flow spreader and a filter element for liquid filter systems.

### BACKGROUND

Filter systems are used to separate components of fluid mixtures by passing a fluid to be filtered through a filter medium that permits the passage of the bulk fluid but prevents passage of other components present in the fluid. For example, solid components may be separated from a liquid by filtration, or particulate solids or liquids in the form of aerosols may be separated from a gaseous fluid by filtration.

Liquid filter systems can comprise a hollow cylindrical filter element, where fluid flows through a filter material on the cylindrical wall of the filter element to provide filtration of the fluid. Typically, a cylindrical filter element may be disposed in a chamber where a liquid to be filtered flows from an inlet of the chamber, through the cylindrical wall of the filter element into the internal volume of the filter element, and exits via an opening at one end of the filter element. Such cylindrical filter elements typically have an opening at one end to discharge filtered liquid (the opening connected to an outlet of the chamber), and, at the opposing end, means for securing the filter element and/or a handle for removing the filter element for replacement. Such filter systems are designed to introduce liquid to be filtered from the side of the filter element so that it is directed towards the curved side walls of the filter element that comprise the filter material and through which the liquid is filtered.

### SUMMARY

When fluids pass through a filter, there is a fall in pressure of the fluid across the filter, referred to as pressure drop, from the inlet providing the fluid to be filtered to the outlet through which the filtered fluid is provided. Where the pressure of a fluid drops, in order to reuse the filtered fluid it must then be compressed to reverse the pressure drop. Where there is a large pressure drop, more compression is needed, increasing energy consumption. Therefore, it is desired to decrease pressure drop in filter systems.

In typical filter systems where liquid is directed towards the filter material from an inlet, pressure of the liquid flow against the filter is higher at the initial point of contact, i.e. the portion of the filter adjacent to the inlet. It has been found that this uneven pressure of fluid across the filter element leads to increased pressure drop of liquid passing through the filter, and that a single high pressure contact point may increase mechanical wear on the filter and its attachments.

It has been surprisingly found that the pressure drop across a liquid filter may be reduced by use of a flow spreader arranged at an upper end of a filter element to receive and distribute liquid flow around the filter element.

Thus, a first aspect provides a liquid filter system comprising: a chamber having an upper end and a lower end separated by a lateral wall, the chamber having an inlet at its upper end for providing a liquid flow into the chamber and an outlet at its lower end; a filter element having a hollow interior volume defined by a filter element upper end and a filter element lower end separated by a filter wall, the filter element arranged in the chamber to filter the liquid flow by passage through the filter wall into the hollow interior volume to the chamber outlet connected at the filter element lower end; and a flow spreader having an inclined surface forming an apex, the flow spreader arranged at the upper end of the filter element to receive a columnar liquid flow from the inlet of the chamber at the apex of the inclined surface and to provide an annular liquid flow past the upper end of the filter element into an annular gap between the filter wall of the filter element and the lateral wall of the chamber.

By providing a filter system as described, a more equal distribution of pressure across the filter wall of the filter element through which the liquid is filtered may be achieved, which is believed to result in reduced pressure drop through the filter in comparison to typical filter systems. For example, it has been found that a pressure drop reduction of up to 40 % can be achieved in comparison to typical liquid filter systems in which liquid flow is introduced towards the side of the filter element. This can lead to reduced energy consumption due to reduced compression requirements for the initial or the filtered liquid to meet a desired outlet pressure, and/or may increase reliability of output pressure from the filter, reducing instances of insufficient output from the filter system.

The filter element is preferably a generally cylindrical filter element, a curved lateral surface of the generally cylindrical filter element comprising the filter wall. However, it will be appreciated that other arrangements may also be used. It will also be appreciated that while the general shape of the filter element may be generally cylindrical, the walls of the filter element may nonetheless have surface structure that is not planar. For example, in preferred embodiments, the filter wall of the filter element, comprising the filter material through which the liquid is filtered (by allowing passage of liquid whilst restricting passage of solid particulate components), may comprise a pleated wall of filter material, or other arrangements to increase the surface area of the filter wall. The filter wall may comprise a filter material supported by a filter support configured to provide mechanical strength to the filter wall whilst minimising reduction of flow through the filter wall. For example, the filter wall may comprise substantially rigid elongate struts, which may be in the form of a grid or a mesh as a support for the filter material, where the gaps between struts is sufficient that flow through the filter material is slower than flow through the filter support (e.g. that obstruction of flow through the support is negligible compared to the filter material).

The filter material present in the filter wall may comprise any suitable material for filtering solid material from a liquid flow and it will be appreciated that the material may be varied depending on the particular liquid to be filtered. For example, the filter material may be varied depending on the particle size of solid components to be filtered or the chemical nature of the liquid to be filtered, such as whether the liquid is an organic liquid such an oil or organic solvent, or is an aqueous liquid, or a mixture such as an emulsion or other biphasic liquid, as well as whether the liquid is corrosive or otherwise reactive. The filter material may for example comprise a woven or non-woven fibrous material such as from glass fibres or other fibres, a paper-based material, a membrane, or any other suitable filter material. Preferably the filter material is a glass fibre material, preferably a pleated glass fibre filter material. In preferred embodiments, the liquid filter system is an oil filtration system, although any suitable liquid may be filtered using the present filter system.

Suitably, the filter element has a hollow interior volume defined by a filter element upper end and a filter element lower end separated by a filter wall. The hollow interior volume is connected to the chamber outlet at the filter element lower end. Suitably, the lower end of the filter element may be sealed around the outlet from the chamber to provide a passage from the interior volume of the filter element to the outlet (e.g. the interior volume of the filter element is in fluid communication with the outlet). For example, the lower end of the filter element is adjacent to the lower wall of the chamber to cover the outlet such that fluid from the inlet of the chamber must pass through the filter wall into the interior volume of the filter element to pass to the outlet. The filter element lower end may seal with the outlet in any suitable way, for example the filter element may seal around the outlet on the lower wall of the chamber through which the outlet passes, for example the outlet may comprise a conduit that extends at least partially into the chamber, where the lower end of the filter element seals around the conduit to provide fluid communication between the interior volume of the filter element and the outlet. In other embodiments, the filter element lower end may comprise a sealing portion configured to extend at least partially into the outlet and to seal around the periphery of the outlet.

The filter element is suitably arranged below the flow spreader, so that the flow spreader can receive the liquid flow from the inlet (preferably via a flow guide) and provide an annular liquid flow past the upper end of the filter element into an annular gap between the filter wall of the filter element and the lateral wall of the chamber. The flow spreader is therefore suitably arranged above filter element in the chamber and may be connected to the upper end of the filter element or may be separate from the filter element and may be arranged above the filter element without being connected to the filter element. Preferably, the flow spreader is connected to the filter element at the filter element upper end. For example, the flow spreader may be provided by an end cap connected to the filter element upper end. Thus, the flow spreader may have a cross-section at its lower end corresponding to the upper end of the filter element, for example where the filter wall of the filter element extends around the periphery (e.g. the circumference) of the lower end of the flow spreader. The flow spreader may attach to a filter element upper wall at the upper end of the filter element, for example by any suitable attachment such as adhesive, screw fixings, bolts, interference fits and the like. Thus, the filter element and/or the flow spreader may comprise an attachment for coupling the flow spreader to the upper end of the filter element. In some embodiments, the flow spreader may be integral to the filter element upper wall, for example wherein the lower surface of the flow spreader provides the upper wall of the filter element hollow interior volume. Thus, the filter wall of the filter element may connect to, and be sealed around, a lower surface of the flow spreader.

The flow spreader suitable has an inclined surface forming an apex configured to receive a columnar liquid flow and provide an annular liquid flow past the flow spreader and past the filter element upper end. The flow spreader is suitably configured to disperse the columnar flow radially outwards from the apex to provide the annular flow. The columnar flow is suitably an undispersed stream provided from the inlet in the sense that the flow from the inlet is optionally guided by changing the direction of the stream as a whole (e.g. with a flow guide to direct the stream towards the apex), but prior to contacting the flow spreader is not dispersed. Dispersion suitably refers to where portions of the flow are distributed in different directions such as an even outward radial dispersion from the apex of the flow spreader around its periphery (e.g. its circumference).

The flow spreader may have any suitable form and preferably the flow spreader comprises a generally conical form provided by the inclined surface and the apex. It will be appreciated that the generally conical form may for example not be a true cone in the sense that it may have a curved inclined surface from the lower circumference of the flow spreader towards the apex, and that the generally conical form may comprise a truncated cone, such that the apex may form a point or may comprise a flat or curved surface. In some instances, the flow spreader may not be precisely circular in cross section, but may have an oval horizontal cross-section or the cone may be a pyramid-like shape formed from a plurality of flat sides. Preferably, the flow spreader is generally conical having a circular horizontal cross-section. The apex may in some preferred embodiments comprise an attachment means configured to connect to the upper end of the chamber and the inclined surface may extend down from the attachment means (e.g. an elongate element extending from the apex) to the lower periphery of the flow spreader. It will be appreciated that while a generally conical flow spreader is referred to (which may have a circular cross-section), the shape of the annular liquid flow provided by the flow spreader will vary based on the configuration of the flow spreader. Thus, the annular flow may suitably surround the filter element without providing an annular flow having a precisely circular cross-section.

The generally conical form of the flow spreader preferably has an internal angle at the apex of less than 180 degrees, for example less than 160 degrees. The internal angle at the apex may be defined as the internal angle between opposing portions of the inclined surface at the apex. In embodiments, the filter element has a diameter D, and the inclined surface comprises a first curved surface extending to, for example forming, the apex having a radius of curvature of at least 0.5 D, for example at least 0.7 D, and optionally a second curved surface around a lower periphery of the flow spreader (under the first curved surface) having a radius of curvature of less than 0.4 D, for example less than 0.25 D. It has been found that this configuration can provide advantageously equal distribution of liquid around the filter element. The second curved surface of the inclined surface having a lower diameter of curvature than the first curved surface permits smooth cooperation of the flow spreader with the upper end of the filter element without disrupting flow, for example the second curved surface may be configured to bring the inclined surface parallel with the filter element filter wall at its lower end to avoid creating turbulence at a join between the flow spreader and the filter element.

The chamber of the filter system may be any suitable chamber for holding the filter element and the flow spreader such that the liquid flow from the inlet into the chamber may pass through the filter wall of the filter element into the hollow interior of the filter element and to the outlet. Suitably, as described the filter element is sealed around the outlet so that liquid from the inlet in the chamber must pass through the filter wall to flow through the outlet. While flow through the filter system may be driven by liquid pressure at the inlet, the system is preferably configured to provide the liquid flow from the inlet to the lower end of the chamber at least partially under gravity. For example, in use the upper end of the chamber is suitably disposed above the lower end, and the lateral wall vertically separates the upper end from the lower end.

The chamber may be a substantially cylindrical chamber, with its upper and lower ends separated by a curved lateral wall. In some embodiments the lateral wall of the chamber may be tapered from its upper end to its lower end (e.g. towards the outlet), for example to provide a chamber at least partially in the form of a truncated cone. Preferably, the chamber is tapered from its upper end to its lower end so that the annular gap between the lateral wall of the chamber and the filter wall decreases in size from the filter element upper end to the filter element lower end. This may help to provide equal pressure of liquid against the length of the filter wall of the filter element from the filter element upper end to its lower end. The chamber lateral wall may form an angle with the longitudinal axis (the longitudinal axis extending through the upper and lower ends of the chamber) of the chamber of 0.5° or more, preferably 1° or more, for example about 2°. Preferably the lateral wall may form an angle with the longitudinal axis of less than 5°, for example no more than 4° or no more than 3°.

The inlet to the chamber is suitably arranged at the upper end of the chamber to provide a flow of liquid from the inlet towards the apex of the flow spreader. The inlet itself (e.g. the placement of the inlet and direction of flow from the inlet into the chamber) may be configured to direct flow onto the apex flow spreader in the chamber, or the inlet may be arranged to direct flow into the chamber and a flow guide provided in the chamber configured to direct the liquid flow from the inlet towards the apex of the flow spreader.

Preferably, the filter system comprises a flow guide configured to provide a change of direction of the flow path of the liquid flow between the inlet into the chamber and the flow spreader. For example, the flow guide is preferably configured to direct flow from the inlet into the chamber towards the apex of the flow spreader. Any suitable flow guide may be used, though preferably the flow guide is provided by a curved surface arranged in the path of liquid flow from the inlet, wherein the curved surface is configured to redirect the liquid flow from the inlet towards the flow spreader. The curved surface may in preferred embodiments comprise a curved upper wall of the chamber (i.e. where the flow guide is integral to the upper wall of the chamber). For example, the chamber may comprise a removable upper wall (which may for example be used to remove or replace a filter element in the chamber), where the flow guide is integrated with the removable upper wall, for example where the flow guide is formed by a lower surface of the removable wall. The curved surface of the flow guide may extend from the inlet to the chamber, for example such that the curved surface abuts the chamber wall comprising the inlet. The curved surface of the flow guide may be configured to match the shape of the inlet, for example the curved surface of the flow guide may form an extension of an upper surface of a flow passage supplying the inlet. For instance, the inlet may comprise a tubular flow passage upstream of the chamber where the flow guide provides an extension of the upper surface of the tubular passage into the chamber that is configured to direct liquid flow from the inlet down towards the flow spreader.

In preferred embodiments, the inlet to the chamber is configured to direct liquid flow into the chamber above the flow spreader and at least partially (for example substantially) perpendicularly to the axis of the chamber and/or the filter element (e.g. substantially perpendicular to the direction of flow from the flow guide or the flow spreader to the chamber outlet). By including a flow guide between the inlet and the flow spreader, the overall size of the filter system may be reduced by avoiding the need for flow passages above the chamber upper end.

In some embodiments, the filter system may comprise an inlet configured to direct liquid directly towards the flow spreader without the use of a flow guide within the chamber. For example, the inlet may be disposed on an upper wall of the chamber and arranged to direct liquid down towards the flow spreader in the chamber. The system may include a bend in the flow path of the liquid flow upstream of the inlet into the chamber, where the inlet is arranged to direct liquid flow downwards towards the flow spreader, and the flow spreader is offset from a central axis of the inlet towards the outside of the bend. In this way, the position of the flow spreader may account for increased pressure of the liquid from the inlet at the outside of the bend to equalise flow distribution around the filter element.

Preferably, the filter element and/or the flow spreader comprise attachment means configured to hold the filter element and/or the flow spreader in the chamber, for example to couple to the upper end of the chamber. As will be appreciated, where the flow spreader is attached to the filter element, only one of the filter element or flow spreader may be directly coupled to the upper end of the chamber. In preferred embodiments, the flow spreader is attached to or integral to the filter element and the flow spreader comprises the attachment means configured to couple to the chamber. As will also be appreciated, the filter element will be suitably coupled to the chamber at its lower end at the outlet of the chamber to provide flow from the hollow interior volume of the filter element to the outlet.

The attachment means comprises one or more elongate members extending from the flow spreader and/or the filter element and configured to couple to the upper end of the chamber. The one or more elongate members may suitably provide coupling to the chamber whilst minimising disruption of flow from the inlet to the flow spreader or from the flow spreader past the upper end of the filter element. The one or more elongate members may be configured to couple the flow spreader and/or the filter element to the upper end of the chamber in any suitable way, for example by a fixed connection such as a screw connection (e.g. screwing into an upper wall of the chamber, or extending from the upper wall to screw into the flow spreader or filter element) or using adhesive, interference fit and the like. In some preferred embodiments, the attachment means comprises an interlocking portion attached to the one or more elongate members, the interlocking portion configured to interlock with the upper end of the chamber to hold the filter element and/or flow spreader in place (which may therefore not fixedly attach to the upper end of the chamber but simply abut the upper end of the chamber to prevent movement of the filter element and/or flow spreader). In some embodiments the attachment means may comprise pins extending between the chamber and the filter element and/or flow spreader, for example the pins may be attachable to the chamber and removably attached to the flow spreader and/or filter element to enable removal and replacement of the filter element. The exact attachment means may be suitably varied depending on the requirements of the system.

As described previously, in preferred embodiments the chamber comprises a removable upper wall. Preferably, the attachment means is coupled to the removable upper wall to enable removal of the filter element and flow spreader together with the upper wall. In this way, removal of the upper wall may enable more efficient removal and replacement of the filter element without the need to remove multiple parts of the system separately. The attachment means may therefore be configured to couple to the removable upper wall of the chamber so that the flow spreader and filter element can hang from the removable upper wall when it is removed. Thus, the attachment means may suitably vary based on the weight of the flow spreader and filter element to provide sufficient strength.

The number of elongate elements of the attachment means may therefore vary depending on the size, and therefore the weight, of the filter element and flow spreader (which may for example vary based on the size and throughput requirements of the filter system). The attachment means may in preferred embodiments comprise a single elongate element, which preferably extends from the apex of the flow spreader to the upper end of the chamber (e.g. the removable upper wall). This may provide a simple and efficient means where the weight of the removable upper wall and/or the filter element and flow spreader is relatively low. In other embodiments, a plurality of elongate elements are present, and are preferably distributed around the periphery of the flow spreader and filter element to provide even support. Where a plurality of elongate elements are used in the attachment means, the elongate elements may each individually couple to the chamber, or the plurality of elongate elements may each be connected at their upper ends to a common attachment point. For example, the attachment means may comprise a plurality of elongate elements extending up from the flow spreader and/or the filter element, the elongate elements connected to an interlocking portion configured to couple to the removable upper wall of the chamber. The interlocking portion may be configured to at least partially surround a portion of the upper wall of the chamber, for example, the interlocking portion may at least partially surround and abut a flow guide of the upper wall. In some embodiments, the attachment means may be configured to hold the filter element and/or flow spreader in place within the chamber, but may not be directly coupled to the upper wall of the chamber. In this case, a removable upper wall may be separately removed form the chamber form the filter element and flow spreader, which may be advantageous where the removable upper wall and/or the filter element are relatively heavy and are more easily removed separately (for example where the removable upper wall weighs more than 15 kg).

A further aspect provides a filter element comprising: a filter element upper end and a filter element lower end separated by a filter wall, the filter element configured for connection within a chamber of a liquid filter system under a flow spreader at the filter element upper end, the flow spreader having an inclined surface forming an apex configured to receive a columnar liquid flow from an inlet at an upper end of the chamber and to provide an annular liquid flow past the filter element upper end into an annular gap between the filter wall and a lateral wall of the chamber; and a hollow interior volume defined by the filter element upper and lower ends and the filter wall, the filter element configured to filter a liquid flow by passage through the filter wall into the hollow interior volume, the filter element configured to connect to an outlet at a lower end of the chamber to receive a filtered liquid flow from the hollow interior volume.

As will be appreciated, the filter element of this aspect is suitably a filter element for use in a filter system as described herein and the filter element may be as described previously herein in relation to the filter system.

For example, the filter element may comprise the flow spreader connected to the filter element at the filter element upper end, preferably wherein the flow spreader is provided by an end cap connected to the filter element upper end. The flow spreader many suitably be as described previously herein.

The filter element and/or the flow spreader may preferably comprise attachment means as defined previously herein.

Preferably, the filter element is generally cylindrical, a curved lateral surface of the generally cylindrical filter element comprising the filter wall, wherein the filter wall may comprise a filter material such as a pleated glass fibre material.

A further aspect provides a flow spreader comprising: an inclined surface forming an apex, the flow spreader configured for connection within a chamber at a filter element upper end to receive a columnar liquid flow at the apex of the inclined surface from an inlet at an upper end of the chamber, and to provide an annular liquid flow past the filter element upper end into an annular gap between a filter wall of the filter element and a lateral wall of the chamber, the filter wall extending from the filter element upper end to a filter element lower end.

As will be appreciated, the flow spreader of this aspect is suitably a flow spreader for use in a filter system as described herein and the flow spreader may be as described previously herein in relation to the filter system.

For example, the flow spreader is preferably configured to connect to the filter element upper end, for example the flow spreader is preferably configured to provide an end cap connected to the filter element upper end. Thus the flow spreader may comprise attachment means for coupling to the upper end of the filter element.

The flow spreader preferably comprises attachment means configured to couple to the upper end of the chamber, preferably as defined previously herein. For example, the attachment means preferably comprises one or more elongate members extending from the flow spreader and configured to couple to the upper end of the chamber, such as where the elongate member comprises a screw connection for screwing into an upper wall of the chamber or wherein the attachment means comprises an interlocking portion attached to the one or more elongate members configured to grip the upper end of the chamber.

Preferably, the flow spreader comprises a generally conical form provided by the inclined surface and the apex. The generally conical form preferably has an internal angle at the apex of less than 180 degrees, for example less than 160 degrees, as described previously herein. Preferably, a lower periphery of the flow spreader has a diameter D, and the inclined surface comprises a first curved surface forming the apex having a radius of curvature of at least 0.5 D, for example at least 0.7 D, and optionally a second curved surface around a lower periphery of the flow spreader having a radius of curvature of less than 0.4 D, for example less than 0.25 D, as described previously herein.

A further aspect provides a method for filtering a liquid using a filter system as described herein. For example, the method may comprise the steps of providing a columnar liquid flow into a chamber comprising a filter element; distributing the columnar flow into an annular liquid flow past an upper end of the filter element into an annular gap between a filter wall of the filter element and a lateral wall of the chamber; and providing a filtered liquid from an outlet of the chamber in fluid communication with a hollow interior volume of the filter element. The method of this aspect and the features of the filter system may be as defined previously herein.

Aspects of the disclosure may be provided in conjunction with each other, and features of one aspect may be applied to other aspects.

### DETAILED DESCRIPTION OF THE DRAWINGS

Embodiments of the disclosure will now be described, by way of example only, with reference to the accompanying drawings, in which:

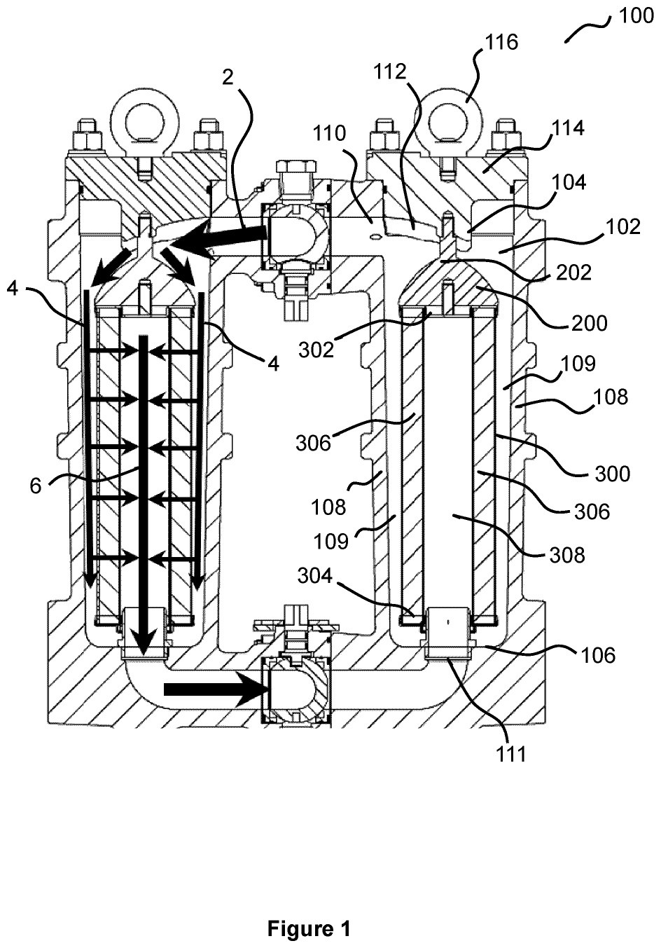

FIG. 1 shows a sectional view of a filter system according to the disclosure;

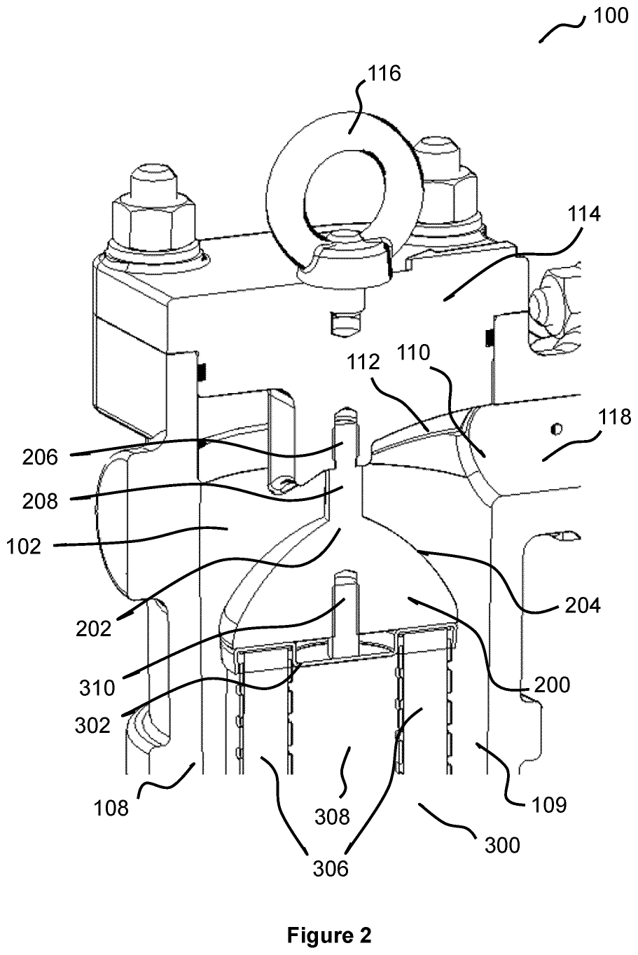

FIG. 2 shows a sectional view of the upper end of the filter system showing a flow spreader and flow guide;

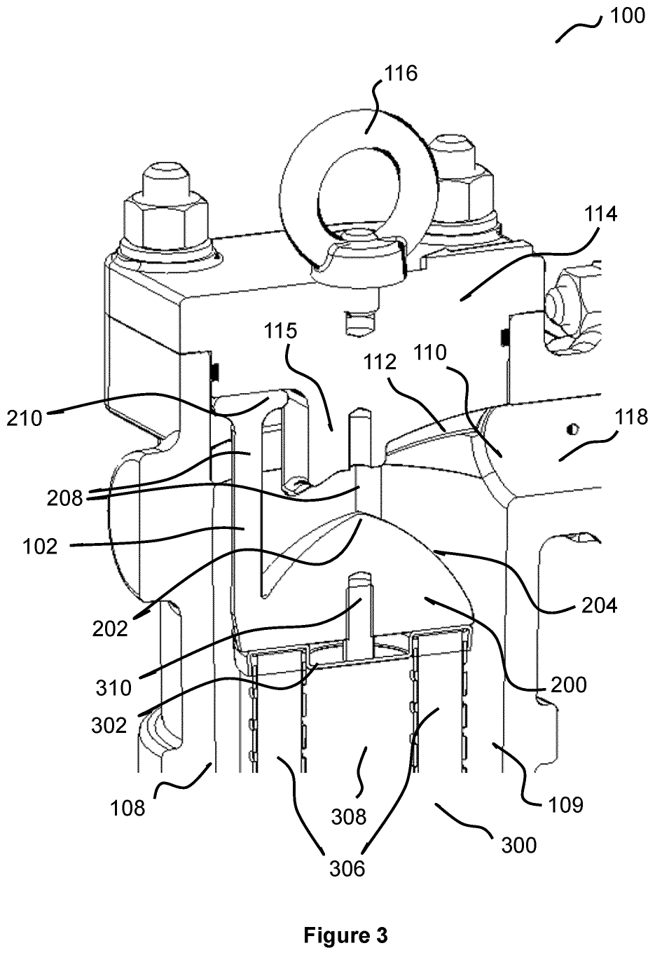

FIG. 3 shows an alternative sectional view of the upper end of the filter system showing a flow spreader and flow guide;

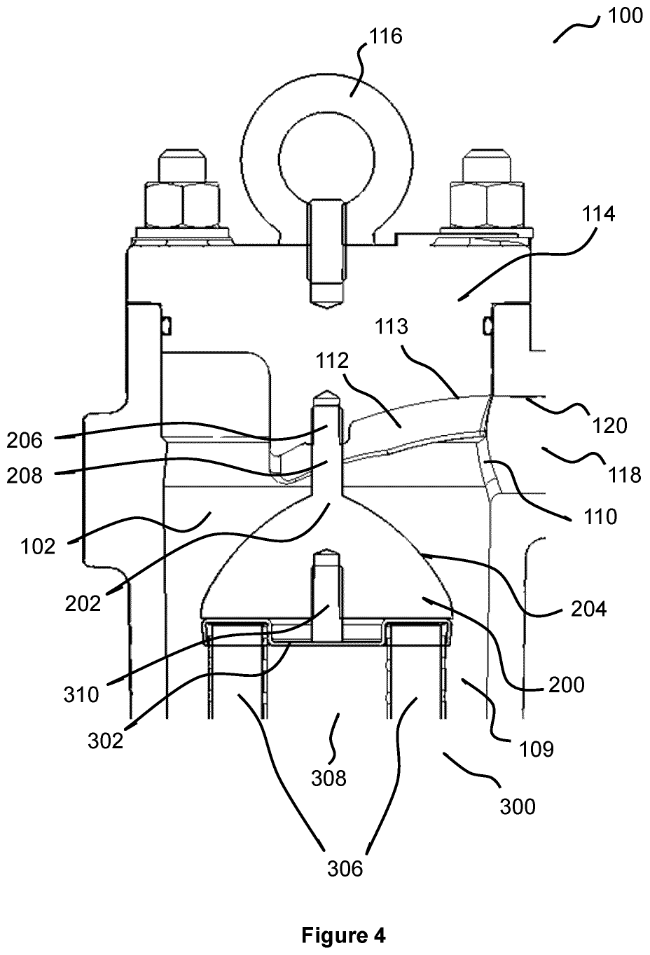

FIG. 4 shows a further sectional view of the upper end of the filter system shown in FIGS. 1 and 2;

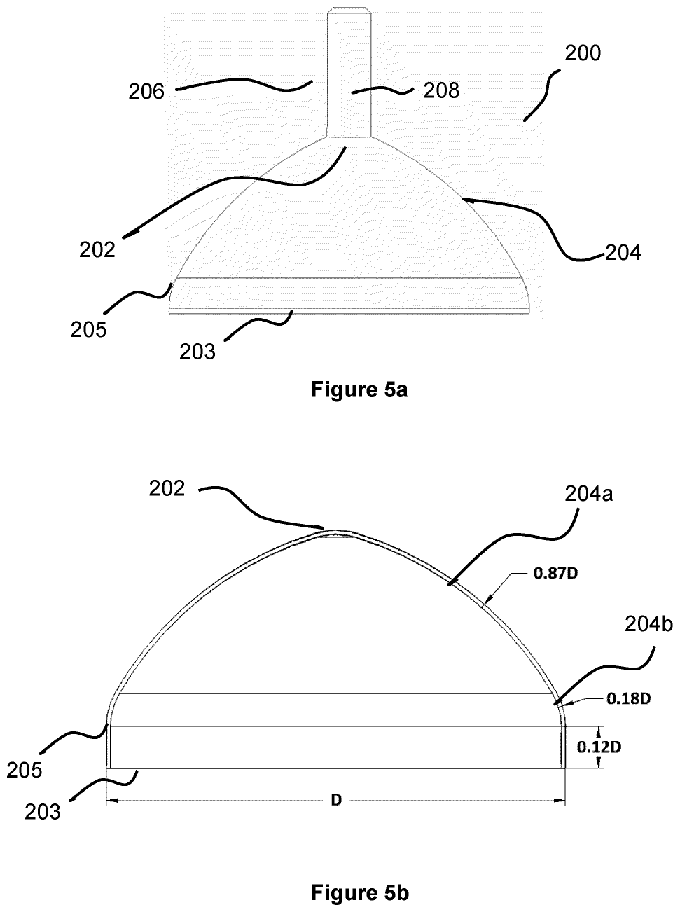

FIGS. 5a and 5b show sectional and schematic views of a flow spreader according to the disclosure;

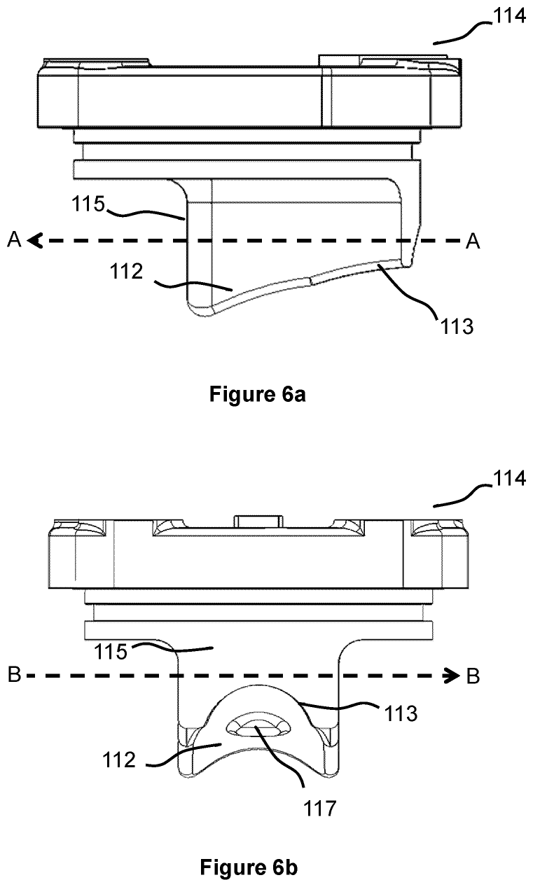

FIGS. 6a and 6b show views of a removable upper wall comprising a flow guide; and

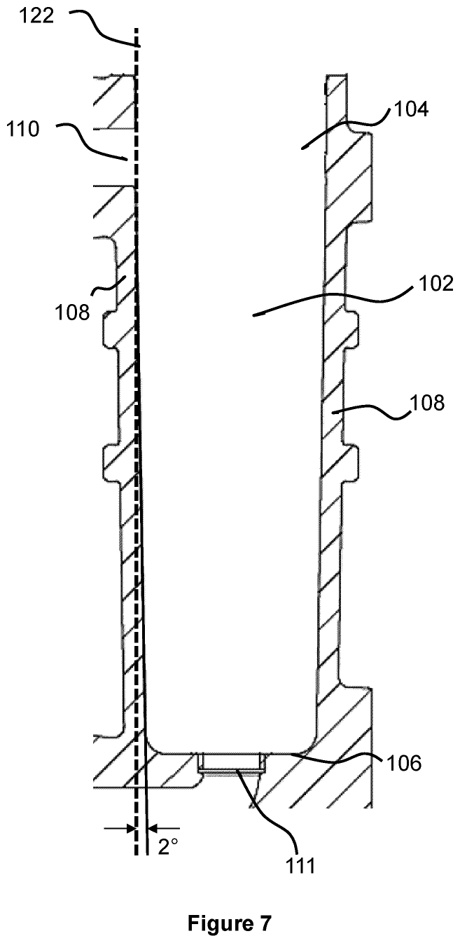

FIG. 7 shows a sectional view of the filter system chamber.

In the figures, like numerals denote like elements.

FIG. 1 shows a filter system 100 comprising a filter chamber 102 having an upper end 104 and a lower end 106 separated by a lateral wall 108. The chamber 102 is tapered from the upper end 104 to the lower end 106 to provide a truncated conical chamber. The chamber 102 comprises an inlet 110 configured to provide a flow of liquid into the chamber 102, and an outlet 111 for receiving filtered liquid.

A cylindrical filter element 300 is disposed in the chamber 102 and comprises a filter element upper end 302 and a filter element lower end 304 separated by a curved cylindrical filter wall 306. The filter wall 306 comprises a pleated glass filter material, although it will be appreciated that any suitable filter material may be used. The filter wall 306 is separated from the lateral wall 108 by an annular gap 109 that narrows from the upper end 302 of the filter element to the lower end 304 of the filter element due to the tapered configuration of the chamber lateral wall 108. The filter element lower end 304 is connected to and sealed with the outlet 111 such that a hollow internal volume 308 of the filter element is in fluid communication with the outlet 111. The filter system comprises a flow spreader 200 disposed at the upper end 302 of the filter element 300 between the inlet 110 and the filter element 300. As shown in FIG. 1, the filter element 300 is disposed in the chamber 102 below the flow spreader 200 such that the flow spreader 200 separates the filter element from the inlet 110.

As described, the chamber 102 comprises an inlet 110 at its upper end 104 configured to provide a flow of liquid into the chamber 102. The inlet 110 is arranged to direct liquid into the chamber 102 horizontally and perpendicularly to the direction of flow from the inlet to the outlet (from the upper end 104 of the chamber 102 to the lower end 106). The chamber upper end 104 comprises a removable upper wall 114. The removable upper wall 114 comprises a flow guide 112 on its lower surface. The flow guide 112 comprises a curved surface arranged such that liquid flow entering the chamber 102 via the inlet 110 is directed by the curved surface of the flow guide 112 towards the apex 302 of the flow spreader 200.

With reference to the left-hand chamber of the filter system 100 in FIG. 1, the liquid flow path through a chamber 102 of the system is shown schematically. For ease of reference the flow is shown on the left-hand chamber, but it will be appreciated that this is a mirror image of the right-hand chamber and comprises corresponding and equivalent elements to those described previously. A liquid flow to be filtered (for example an oil, although any suitable liquid may be used) enters the chamber 102 via the inlet 110 and is directed by the flow guide 112 as a columnar flow 2 to the apex 202 of the flow spreader 200. The columnar liquid flow 2 is dispersed by the flow spreader 200 to provide an annular liquid flow 4 past the upper end 302 of the filter element 300 into the annular gap 109. The annular liquid flow 4 passes radially inward through the filter material of the filter wall 306 into the hollow interior volume 308 to provide a filtered liquid flow 6 that leaves the chamber 102 via the outlet 111. As shown schematically in FIG. 1, the use of the flow spreader 300 above the filter element 200 provides an equal annular flow 4 around the circumference of the filter wall 306, in contrast to the uneven pressure and flow distribution that would result from a typical filter system in which an inlet into the chamber is disposed below the upper end of the filter element though the lateral wall of the chamber and directed horizontally towards the filter wall of the filter element. As shown in FIG. 1, the removable upper wall 114 comprises a handle 116 for lifting and removing the upper wall 114. The handle may be suitably configured for removal by mechanical means or manually depending on requirements. As the flow spreader 200 is attached to the upper wall 114 and the filter element 200, removal of the upper wall 114 can simultaneously remove the filter element 300 from the chamber 102 for maintenance, for instance in order to replace the filter element 300 and/or the flow spreader 200.

The filter system shown in FIG. 1 is shown as having two equivalent filter chambers 102, which may for example enable continuous use of the filter system while one of the filters is maintained, for example by replacing the filter element 300. Nonetheless, it will be appreciated that the presence of two filter chambers 102 is not required.

FIG. 2 shows a close-up sectional view of the upper end of the filter system 100. As shown, the inlet 110 is an exit into the chamber 102 from a tubular conduit 118 configured to convey the liquid flow to be filtered to the inlet 110. The flow guide 112 is arranged adjacent the inlet 110 to direct the columnar liquid flow from the inlet 110 to the apex 202 of the flow spreader 200. The flow spreader 200 has a generally conical form and comprises a curved inclined surface 204 extending upwards and radially inwards from the periphery of the lower end of the flow spreader 200 towards the apex 202. The inclined surface 204 of the flow spreader 200 disperses flow from the inlet 110 (via the flow guide 112) radially outwards from the apex 202 as an annular flow into the annular gap 109 separating the filter element filter wall 306 from the lateral wall 108 of the chamber 102.

The flow spreader 200 is fixedly connected to the chamber 102 by an attachment 206 comprising an elongate member 208 extending from the apex 202 to the removable upper wall 114 of the chamber 102 (which may for example screw into the removable upper wall 114). The flow spreader 200 is also fixedly connected as an end cap onto the upper end 302 of the filter element 300 by an attachment 310, which may for example comprise a screw connection configured to screw into the flow spreader 200. The attachments 206 and 310 advantageously permit the flow spreader 200 and the filter element 300 to be removed from the chamber 102 by removal of the upper wall 114, for example using handle 116.

FIG. 3 shows an alternative embodiment of the filter system 100 in which the flow spreader 200 is coupled to the removable upper wall 114 by an attachment means comprising a plurality of elongate elements 208 and an interlocking portion 210. The attachment means of the embodiment shown in FIG. 3 comprises three elongate elements 208 distributed evenly around the circumference of the flow spreader 200 (the third elongate element in the foreground not shown due to the cross-section). As shown in FIG. 3, the elongate elements 208 are circumferentially disposed around the flow spreader 200 to provide an unobstructed path from the inlet 110 to the apex 202 via the flow guide 112 (one of the elongate elements disposed at a side of the flow spreader 200 opposite the inlet 110). The interlocking portion 210 partially surrounds (and extends circumferentially around) a downward projecting portion 115 of the upper wall 114 (the downward projecting portion comprising the flow guide 112), so as to interlock with the downward projecting portion 115 of the upper wall 114. For example, the interlocking portion 210 comprises a horseshoe shaped element that extends around the downward projecting portion 115 of the upper wall 114. Thus, the interlocking portion 210 does not fixedly attach to the upper wall 114 but grips the upper wall 114 to hold the flow spreader 200 (and consequently the filter element 300) in place and to permit the flow spreader 200 to hang from the upper wall 114 and be removed simultaneously with the upper wall 114.

FIG. 4 shows another cross-sectional horizontal view of the upper end of the filter system 100 shown in FIGS. 1 and 2. As shown in FIG. 4, the upper wall 120 of the tubular conduit 118 is aligned with a curved surface 113 of the flow guide 112 so as to provide minimal disruption to the columnar liquid flow from the inlet 110 (i.e. the curved surface 113 is arranged and configured to align with the upper periphery of the inlet 110).

FIG. 5a shows a side-on view of a flow spreader 200 for use in the filter system 100 (in particular a flow spreader as shown in FIGS. 1, 2 and 4). The flow spreader 200 is a generally conical form having a curved inclined surface 204 extending upwards and radially inwards from the periphery of a lower wall 203 to an apex 202. The apex 202 comprises an attachment means 206 formed from an elongate element 208 configured to couple with the upper wall 114 of the chamber 102 of the filter system 100. While the elongate member 208 extends from the apex 202, it will be appreciated that an elongate member 208 for coupling to the chamber 102 may extend from any suitable position on the flow spreader 200 and may comprise a single elongate element 208 or a plurality of elongate elements 208. Though not shown in FIG. 5a, a plurality of elongate elements 208 are preferably disposed circumferentially around the lower periphery 205 of the flow spreader 200, and may each fixedly attach to the chamber 102 (preferably the upper wall 114), or may attach to an interlocking portion 210 as for example shown in FIG. 3.

FIG. 5b shows schematically an example of the relative dimensions of a flow spreader 200 for use in the filter system 100. The inclined surface 204 from the apex 202 to the lower periphery 205 of the lower wall 203 comprises a first curved surface 204a forming the apex 202 and a second curved surface 204b around the lower periphery 205 to join the first curved surface 204a to the lower wall 203. As shown in FIG. 5b, the flow spreader has a diameter D and the first curved surface 204a has a radius of curvature of 0.87 D and the second curved surface has a radius of curvature of 0.18 D. While in FIG. 5b a straight portion of the flow spreader 200 of diameter D and length 0.12 D is shown below the second curved surface 204b, it will be appreciated that such a straight portion is optional and the lower wall 203 may join directly to the second curved surface 204b (for example as shown in FIG. 5a). It will also be appreciated that FIG. 5b is a schematic representation and does not show any attachment means 206 or elongate members 208. In embodiments, the flow spreader may not comprise attachment means 206 for coupling to the chamber 102 directly (e.g. as shown in FIG. 5b), but may comprise attachment means to couple to the upper end 302 of the filter element 300, where the filter element 300 may then be coupled to the chamber 102 to secure both the filter element 300 and the flow spreader 200.

FIGS. 6a and 6b show two perpendicular side views of the removable upper wall 114 of the chamber 102 which comprises the flow guide 112. FIG. 6b shows an end-on view along the axis AA shown in FIG. 6a, and FIG. 6a shows a side-on view along the axis BB shown in FIG. 6b. As shown in FIG. 6a, the removable upper wall includes a downward projecting portion 115 that comprises the flow guide 112. As described in relation to FIG. 4, the flow guide 112 comprises a curved surface 113 that is configured to align with an upper wall 120 of the tubular conduit 118 (i.e. to align with the upper periphery of the inlet 110) and is configured to extend radially into the chamber 102 away from the inlet 110, towards the apex 202 of the flow spreader (disposed below the flow guide 112). FIG. 6b shows the curvature of the curved surface 113 to align with the upper periphery of the inlet 110. The inlet 110 has a substantially circular cross-section and so the curved surface 113, where it is configured to meet the inlet 110, suitably forms an arc of a circle corresponding to the size of the inlet 110. As shown in FIG. 6b, the flow guide may comprise an opening 117 configured to receive an attachment 206 from the flow spreader 200 to couple the flow spreader 200 to the upper wall 114.

FIG. 7 shows a cross-sectional view of the chamber 102 of the filter system 100 comprising the inlet 110 at the upper end 104 of the chamber 102 and the outlet 111 at the lower end 106 of the chamber 102. The chamber 102 is in the form of a truncated cone, where the lateral wall 108 of the chamber 102 is tapered from the upper end 104 of the chamber 102 to the lower end 106. As shown in FIG. 7, the lateral wall 108 is angularly offset from a vertical axis 122 (the vertical axis parallel with the longitudinal central axis of the conical chamber 102). In FIG. 7, the angular offset is 2°, which has been found to provide advantageous flow through the filter system, though it will be appreciated that the angle may suitably be varied in other embodiments.

1. A liquid filter system comprising:
a chamber having an upper end and a lower end separated by a lateral wall, the chamber having an inlet at its upper end for providing a liquid flow into the chamber and an outlet at its lower end;
a filter element having a hollow interior volume defined by a filter element upper end and a filter element lower end separated by a filter wall, the filter element arranged in the chamber to filter the liquid flow by passage through the filter wall into the hollow interior volume to the chamber outlet connected at the filter element lower end; and
a flow spreader having an inclined surface forming an apex, the flow spreader arranged at the upper end of the filter element to receive a columnar liquid flow from the inlet of the chamber at the apex of the inclined surface and to provide an annular liquid flow past the upper end of the filter element into an annular gap between the filter wall of the filter element and the lateral wall of the chamber.

2. A filter system according to claim 1, wherein the flow spreader is connected to the filter element at the filter element upper end, for example wherein the flow spreader is provided by an end cap connected to the filter element upper end.

3. A filter system according to claim 1, wherein the filter element is generally cylindrical, a curved lateral surface of the generally cylindrical filter element comprising the filter wall.

4. A filter system according to claim 1, wherein the flow spreader comprises a generally conical form provided by the inclined surface and the apex.

5. A filter system according to claim 4, wherein the generally conical form has an internal angle at the apex of less than 180 degrees, for example less than 160 degrees.

6. A filter system according to claim 4, wherein the filter element has a diameter D, and the inclined surface comprises a first curved surface forming the apex having a radius of curvature of at least 0.5 D and optionally a second curved surface around a lower periphery of the flow spreader having a radius of curvature of less than 0.4 D.

7. A filter system according to claim 1, wherein the filter element and/or the flow spreader comprise attachment means configured to couple to the upper end of the chamber.

8. A filter system according to claim 7, wherein the attachment means comprises one or more elongate members extending from the flow spreader and/or the filter element configured to couple to the upper end of the chamber, for example wherein the elongate member is configured to couple to the upper end of the chamber by screwing into an upper wall of the chamber or wherein the attachment means comprises an interlocking portion attached to the one or more elongate members and configured to interlock with the upper end of the chamber.

9. A filter system according to claim 7, wherein the chamber comprises a removable upper wall and the attachment means is coupled to the removable upper wall to enable removal of the filter element and flow spreader together with the upper wall.

10. A filter system according to claim 1, wherein the filter system comprises a flow guide configured to provide a change of direction of the flow path of the liquid flow between the inlet into the chamber and the flow spreader, for example wherein the flow guide is configured to direct flow from the inlet into the chamber towards the apex of the flow spreader.

11. A filter system according to claim 10, wherein the flow guide is provided by a curved upper wall of the chamber, for example wherein the chamber comprises a removable upper wall and the flow guide is integrated with the removable upper wall.

12. A filter system according to claim 1, wherein the chamber is tapered from its upper end to its lower end so that the annular gap between the lateral wall of the chamber and the filter wall decreases in size from the filter element upper end to the filter element lower end.

13. A filter system according to claim 1, wherein the system is configured to provide the liquid flow from the inlet to the lower end of the chamber at least partially under gravity.

14. A filter element comprising:
a filter element upper end and a filter element lower end separated by a filter wall, the filter element configured for connection within a chamber of a liquid filter system under a flow spreader at the filter element upper end, the flow spreader having an inclined surface forming an apex configured to receive a columnar liquid flow from an inlet at an upper end of the chamber and to provide an annular liquid flow past the filter element upper end into an annular gap between the filter wall and a lateral wall of the chamber; and
a hollow interior volume defined by the filter element upper and lower ends and the filter wall, the filter element configured to filter a liquid flow by passage through the filter wall into the hollow interior volume, the filter element configured to connect to an outlet at a lower end of the chamber to receive a filtered liquid flow from the hollow interior volume.

15. A filter element according to claim 14, wherein the filter element comprises the flow spreader connected to the filter element at the filter element upper end, for example wherein the flow spreader is provided by an end cap connected to the filter element upper end.

16. (canceled)

17. A filter element according to claim 14, wherein the filter element and/or the flow spreader comprise attachment means configured to couple to the upper end of the chamber.

18. A filter element according to claim 14, wherein the filter element is generally cylindrical, a curved lateral surface of the generally cylindrical filter element comprising the filter wall.

19. A flow spreader comprising:
an inclined surface forming an apex, the flow spreader configured for connection within a chamber at a filter element upper end to receive a columnar liquid flow at the apex of the inclined surface from an inlet at an upper end of the chamber, and to provide an annular liquid flow past the filter element upper end into an annular gap between a filter wall of the filter element and a lateral wall of the chamber, the filter wall extending from the filter element upper end to a filter element lower end.

20. (canceled)

21. A flow spreader according to claim 19, wherein the flow spreader comprises attachment means configured to couple to the upper end of the chamber.

22. A flow spreader according to claim 21, wherein the attachment means comprises one or more elongate members extending from the flow spreader and configured to couple to the upper end of the chamber, for example wherein the elongate member comprises a screw connection for screwing into an upper wall of the chamber or wherein the attachment means comprises an interlocking portion attached to the one or more elongate members configured to grip the upper end of the chamber.

23-25. (canceled)
